(19) United States
(12) Patent Application Publication
(10) Pub. No.: US 2020/0138111 A1
(43) Pub. Date: May 7, 2020

(54) SYSTEM AND METHOD FOR MICRO-VAPORIZER USE AUTHORIZATION

(71) Applicant: Avail Vapor, LLC, Richmond, VA (US)

(72) Inventors: Vincent Angelico, Richmond, VA (US); Matt Athayde, Richmond, VA (US); Russell Paul Rogers, Richmond, VA (US)

(21) Appl. No.: 16/670,153

(22) Filed: Oct. 31, 2019

Related U.S. Application Data
(60) Provisional application No. 62/754,685, filed on Nov. 2, 2018.

(51) Int. Cl. A24F 47/00; G06F 21/32

(52) U.S. Cl. CPC A24F 47/008; G06F 21/32

(57) ABSTRACT

A personal vaporizer has a case, a vaporization chamber, a fluid reservoir configured for retaining a vaporizable fluid, a fluid transport structure, a heating element disposed within the vaporization chamber, an air flow passage from one or more air intake openings in the case wall to the vaporization chamber, a vaporization mixture flow passage extending from the vaporization chamber to an exit port, and an activation circuit connected to the heating element. The activation circuit includes a power source, a vaporizer control processor, an authorization control device that is selectively connectable to and disconnectable from the activation circuit, and an activation mechanism configured and positioned for manual operation by a user to selectively complete the activation circuit when the authorization control device is connected and the use authorization criteria are met.

This application claims priority to U.S. Provisional Patent Application 62/754,685, filed Nov. 2, 2018, the complete disclosure of which is incorporated herein by reference.

### BACKGROUND OF THE INVENTION

The invention relates generally to micro-vaporizers and, more particularly, to personal micro-vaporizers having a mechanism for authorizing the use of the device.

Micro-vaporizers are devices in which a vaporizable fluid is drawn from a storage reservoir into a chamber where it is heated to vaporization temperature by a heating element. The vaporized fluid is then drawn or forced from the chamber. In products such as electronic cigarettes (also known as e-cigarettes or personal vaporizers), the vaporized fluid is drawn from the chamber through a mouthpiece and inhaled by the user. In other products the vaporized fluid is dispersed into the atmosphere.

The usual purpose of a device that uses a micro-vaporizer is to dispense one or more active substances using the vaporized fluid. In the case of personal vaporizers, the active substances typically include a flavorant (i.e., a flavoring agent or material) and nicotine. The flavorant and nicotine levels may be selected so as to mimic the experience of smoking a cigarette.

Recently, there has been increased interest in controlling unauthorized use of personal vaporizers. The need exists for methods of controlling use that do not require expensive and potentially bulky additions to the vaporizer device itself.

### SUMMARY OF THE INVENTION

An illustrative aspect of the invention provides a personal vaporizer comprising a vaporizer case defining a vaporizer interior, a vaporization chamber within the vaporizer interior, a fluid reservoir configured for retaining a vaporizable fluid, a fluid transport structure configured for transporting vaporizable fluid from the fluid reservoir to the vaporization chamber, a heating element disposed within the vaporization chamber, an air flow passage from one or more air intake openings in the case wall to the vaporization chamber, and a vaporization mixture flow passage extending from the vaporization chamber to an exit port. The vaporizer further comprises an activation circuit connected to the heating element and configured to activate the heating element if use authorization criteria are met. The circuit comprises a power source, a vaporizer control processor, an authorization control device that is selectively connectable to and disconnectable from the activation circuit, and an activation mechanism configured and positioned for manual operation by a user to selectively complete the activation circuit when the authorization control device is connected and the use authorization criteria are met.

Another illustrative aspect of the invention provides a method of authorizing use of a personal vaporizer having a vaporizer control processor, a vaporizer data storage medium, a communication port and an activation circuit including a heating element, an activation switch, and a power supply, the activating circuit being in a normally open configuration. The method comprises establishing data communication between the vaporizer control processor and an authorizing processing system, receiving, by the vaporizer control processor from the authorizing processing system, first authorization information, and storing the first authorization information in the vaporizer data storage medium. The method further comprises connecting an authorization control device to the communication port of the vaporizer and determining, by one of the set consisting of the vaporizer control processor and an authorization control data processor of the authorization control device, using the first authorization information, whether predetermined authorization criteria are met. Responsive to closure of the activation switch by a prospective user and a determination that the predetermined authorization criteria have been met, the vaporizer is activated by closing the activation circuit to allow current to flow from the power supply to the heating element. Responsive to closure of the activation switch by the prospective user and a determination that the predetermined authorization criteria have not been met, the activation circuit is maintained in the open configuration.

Another illustrative aspect of the invention provides a method of authorizing use of a personal vaporizer having a vaporizer control processor, a vaporizer data storage medium, a communication port and an activation circuit including a heating element, an activation switch, and a power supply, the activating circuit being in a normally open configuration. The method comprises providing an authorization control device having an authorization device data storage medium, determining a biometric characteristic of an authorized user of the vaporizer, and permanently storing in the authorization device storage medium by an authorization processing system, the biometric characteristic. The method further comprises connecting the authorization control device to the communication port of the vaporizer. Biometric data for a prospective user of the vaporizer is received from a biometric sensor by one of the set consisting of the vaporizer control processor and an authorization control data processor of the authorization control device, The method still further comprises determining, by said one of the set consisting of the vaporizer control processor and an authorization control data processor of the authorization control device, whether the biometric data matches the biometric characteristic stored in the authorization device storage medium. Responsive to closure of the activation switch by the prospective user and a determination that the biometric data matches the stored biometric characteristic, the vaporizer is activated by closing the activation circuit to allow current to flow from the power supply to the heating element. Responsive to closure of the activation switch by the prospective user and a determination that the biometric data does not match the stored biometric characteristic, the activation circuit is maintained in the open configuration.

### BRIEF DESCRIPTION OF THE DRAWINGS

The invention can be more fully understood by reading the following detailed description together with the accompanying drawing, in which like reference indicators are used to designate like elements, and in which:

FIG. 1 is a sectioned view of a personal vaporizer according to an embodiment of the invention;

FIG. 2 is a perspective view of an authorization control device usable in conjunction with embodiments of the invention;

FIG. 3A is a schematic representation of an authorization circuit of a personal vaporizer according to an embodiment of the invention;

FIG. 3B is a schematic representation of an authorization circuit of a personal vaporizer according to an embodiment of the invention;

FIG. 4 is a side view of a personal vaporizer according to an embodiment of the invention;

FIG. 5 is a schematic representation of a usage authorization system according to an embodiment of the invention;

FIG. 6 is a flow diagram of a usage authorization control method according to an embodiment of the invention; and

FIG. 7 is a flow diagram of a usage authorization control method according to an embodiment of the invention.

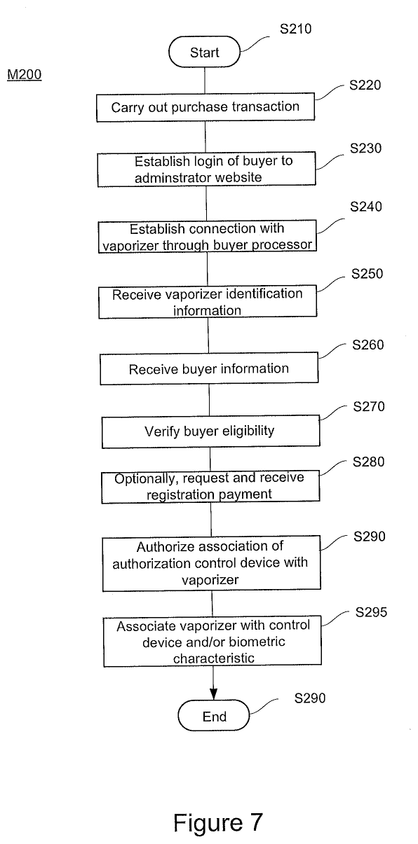

### DETAILED DESCRIPTION OF THE INVENTION

The present invention provides methods of controlling the use of a personal vaporizer. As used herein, the term personal vaporizer refers to a micro-vaporizer in which a fluid is vaporized, mixed with air in a vaporization chamber and passed to an exit chamber where it is inhaled by a user. In typical personal vaporizers, the exit chamber is defined by a mouthpiece (sometimes referred to as a “tip” or “drip tip”) and air is drawn into and through the device by suction applied by the user through the mouthpiece.

The vaporizable fluid used in personal vaporizers typically comprises one or more active materials. As used herein, the term “active material” refers to any material that controllably alters or adds to the vaporization products of the device. Depending on the application, active materials can include, without limitation, plant material, and medications. In the specific instance of personal vaporizers, active materials may include flavorant substances that augment the flavor of the vaporizable fluid. These may include, without limitation, marijuana, hemp, cannabidiol (cbd), citronella, geraniol, mint, thyme, tobacco, nicotine, salvia dorrii, salvia, passiflora incarnata, arctostaphylos uva-ursi, lobelia inflata, lemon grass, cedar wood, clove, cinnamon, coumarin, helio, vanilla, menthol, eucalyptus, peppermint, rosemary, lavender, licorice, and cocoa and any material or structure containing or incorporating any of the foregoing.

While the present invention may be used in conjunction with any form of personal vaporizer, it will be discussed primarily in the context of a typical vaporizer having an air passage into a vaporization chamber, a vaporizable fluid reservoir, a controllable heating element with an associated power source, a fluid transport mechanism for transporting fluid from the reservoir for vaporization by the heat source, and a vapor products flow path to a mouthpiece exit. As will be discussed, the generic personal vaporizer also includes an activation mechanism (e.g., a button on the exterior of the device) connected to an onboard control processor configured to control activation of the heat source. When a user inhales through the mouthpiece, air is drawn into the vaporization chamber. At the same time, the user activates the heat source, which heats and vaporizes fluid from the reservoir. The resulting vapor mixes with the air in the chamber and is then drawn out through the mouthpiece exit and inhaled by the user.

Personal vaporizers according to embodiments of the invention incorporate a mechanism that inhibits or prevents activation of the device unless the user is authorized to do so. As will be discussed, this mechanism may include a communication system whereby the on-board control processor can communicate with and/or be controlled by an external device which may include, without limitation, a dedicated authorization control device, a computer, or a smart phone or tablet.

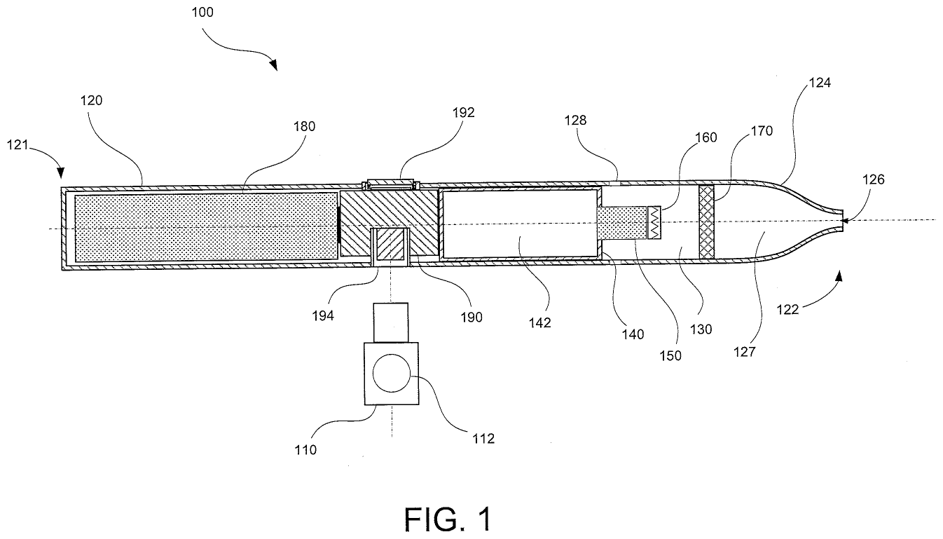

Exemplary embodiments of the invention will now be described in more detail. With reference to FIG. 1, an illustrative personal vaporizer 100 according to an embodiment of the invention has a cylindrical casing 120 having a distal end 121 and a proximal end 122. At its proximal end 122, the casing 120 is formed into a mouthpiece 124 having a passage 126 providing fluid communication between the atmosphere and an exit chamber 127 inside the casing 120. The casing 120 also has one or more air holes 128 to allow air to flow from the atmosphere into a vaporization chamber 130 inside the casing 120 when a relative vacuum is applied at the mouthpiece passage 126 (e.g., by inhalation of a device user). The air drawn in through the air hole(s) 128 passes through a filter 170 which divides the vaporization chamber 130 and the exit chamber 127.

It will be understood that there are many other potential air passage configurations both upstream and downstream of the vaporization chamber, but all personal vaporizers have the general configuration of one or more air inlets upstream of the vaporization chamber and one or more exit ports downstream of the vaporization chamber. One or more passageways may connect the air inlets and the exit ports to the vaporization chamber.

The personal vaporizer 100 further comprises a fluid reservoir 140 in which is disposed a vaporizable fluid 142. The fluid reservoir 140 may be configured as a simple tank in which the fluid 142 is disposed. In some embodiments, the reservoir 140 may be or include a housed or unhoused adsorptive or absorptive material or structure that retains the vaporizable fluid 142. A fluid transport structure 150 is configured and positioned to be in contact with the fluid 142 in the reservoir 140 and for drawing the fluid 142 out of the reservoir 40 and into the vaporization chamber 130. The fluid transport structure 150 may be further configured for bringing the drawn fluid 142 into close proximity or in contact with a heating element 160. The heating element 160 may be configured to heat the vaporizable fluid through any conductive, convective, and/or radiative heat transfer mechanism. In typical vaporizers, the heating element 160 is or includes a resistance element in the form of a wire coil. In some cases, the resistance element is housed within a heat conductive casing.

It will be understood that the configuration and relative positioning of the components of the personal vaporizer 100 may be widely varying and that additional components (e.g., an airflow controller for regulation of the amount of air flow through the holes 128) may be included.

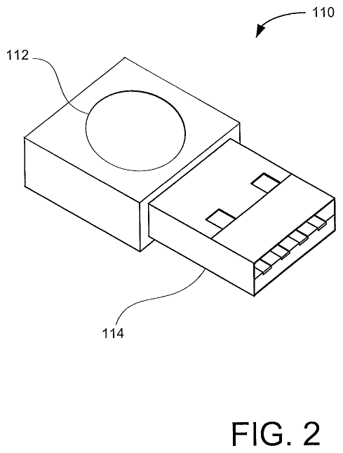

The illustrative personal vaporizer 100 also comprises a battery 180 for powering the heating element 160, an activation switch in the form of a spring-loaded activation button 192, a control processor 190, and a communication port 194. The battery 180, heating element 160, and activation button 192 are connected in an activation circuit that can be selectively completed by the control processor 190 or by a separate authorization control device 110 connectable to the control processor 190 via a plug or other interface 114 which engages and is received into the the communication port 194, thereby providing for data communication between the vaporizer control processor and the authorization control device. In particular embodiments, the communication port 194 is a USB port and the authorization control device 110 comprises a USB connector as the interface 114. See FIG. 2.

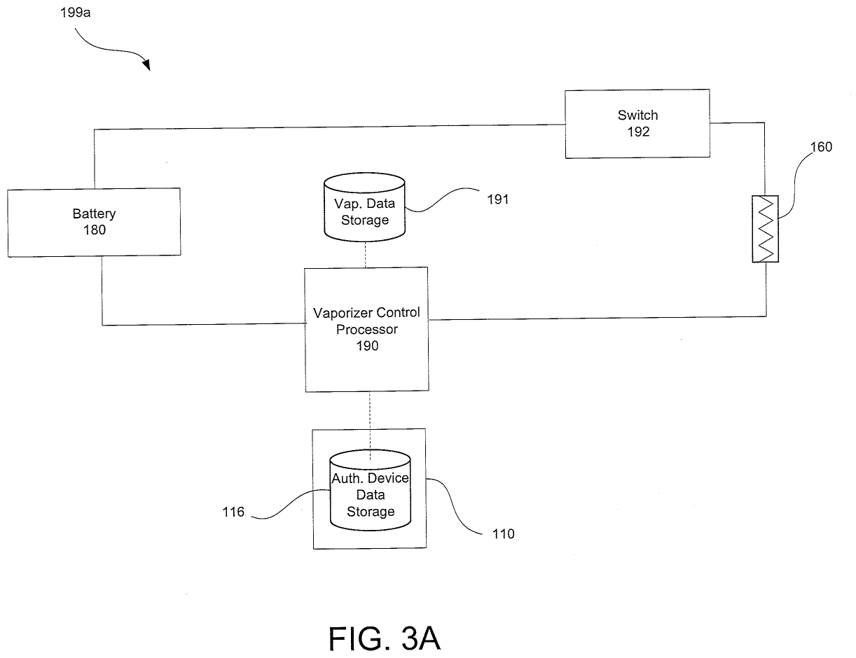

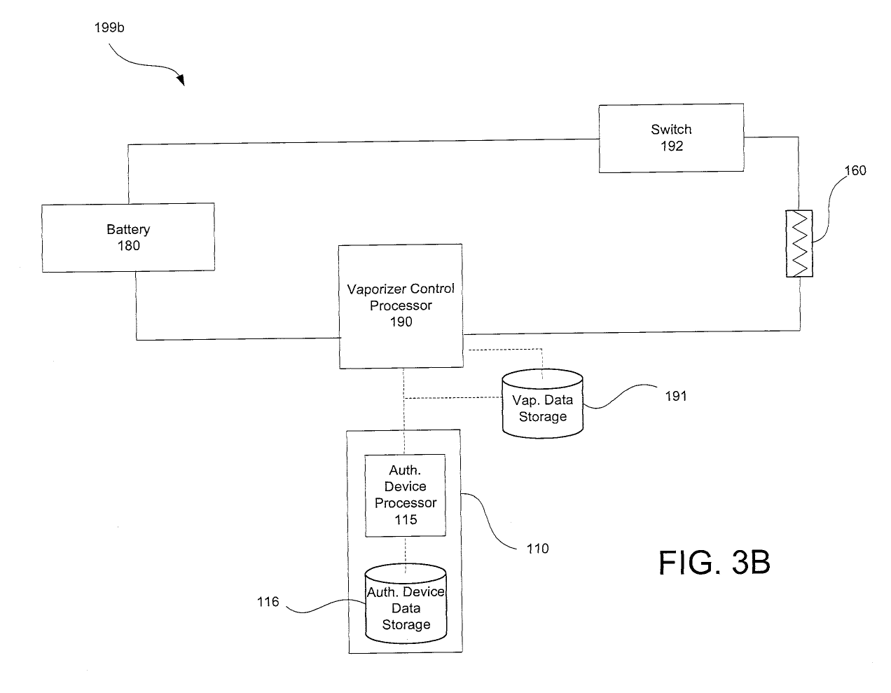

The authorization control device 110 may be a dongle or other hardware device, the presence of which is required to complete the activation circuit. The authorization control device 110 may, itself, complete the activation circuit immediately upon insertion or, as will be discussed, may complete the circuit only upon the satisfaction of certain authorization criteria. In some embodiments such as the activation circuit 199a depicted schematically in FIG. 3A, the authorization control device 110 may include an authorization device data storage medium 116 that is accessible by the vaporizer control processor 190 when the authorization control device 110 is plugged into the communication port 194. In this configuration, the authorization device data storage medium 116 may have authorization information stored therein that can be accessed by the vaporizer control processor 190. The control processor 190 may be configured to use this authorization information to determine if authorization criteria are met. In some embodiments, the vaporizer control processor 190 may retrieve stored authorization information from a vaporizer data storage medium 191 on board the vaporizer 100, which the control processor 190 may then compare to the authorization information from the authorization control device 110. If the authorization criteria are met, the control processor 190 may then allow activation of the vaporizer 100 by a user via the switch 192 (thereby completing the activation circuit 199a causing the heating element 160 to be energized by the power source 180.

In other embodiments such as the activation circuit 199b depicted schematically in FIG. 3B, the authorization control device 110 may include an authorization device data processor 115 in addition to an authorization device data storage medium 116. In this configuration, the authorization device data processor 115 may be in data communication with the on-board vaporizer data storage medium 191 and/or the vaporizer control processor 190. The authorization device data processor 115 may be configured to access authorization information stored in the vaporizer data storage medium 191 to determine if authorization criteria are met. In some embodiments, the authorization device data processor 115 may retrieve stored authorization information from a authorization device data storage medium 116, which the data processor 115 may then compare to the authorization information from the on-board storage medium 191. If the authorization criteria are met, the authorization device data processor 115 may transmit instructions to the vaporizer control processor 190 to allow activation of the vaporizer 100. In some embodiments, the authorization device data processor 115 may itself control circuit activation rather than communicating with the vaporizer control processor 190.

When the activation circuit is completed, a user can activate the heating element 150 by pressing the activation button 192. The personal vaporizer 100 then operates in a conventional manner. In any of the above embodiments, completion of the activation circuit may be prevented unless the authorization control device 110 is present and/or unless predetermined authorization criteria have been met. The authorization criteria may include, for example, a requirement that the authorization control device 110 be previously associated with the vaporizer 100. This association may be verified by the control processor 190 by reading and comparing an identifier of the authorization device 110 to one or more identifiers previously stored in the on-board vaporizer storage medium 191. Alternatively, the authorization device data processor 115 may retrieve authorized identifiers from the on-board vaporizer storage medium 191 and conduct the comparison.

In some embodiments, additional authorization actions and/or information may be required in order to meet the authorization criteria. This may include, in particular, measurement of a biometric characteristics of a prospective user. Accordingly, embodiments of the invention may include mechanisms for obtaining such measurements.

In the particular configuration shown in FIG. 1, the authorization control device 110 includes an optical sensor 112 configured for scanning a unique biometric characteristic of a prospective user. The authorization control device 110 and/or the on-board control processor 190 may be further configured to compare the scanned characteristic to stored characteristics of authorized users. Depending on the embodiment, such authorized user characteristics may be stored in an authorization control device storage medium 116 or an on-board vaporizer storage medium 191. The characteristics of any number of authorized users may be so stored. Only if the scanned characteristic matches the stored characteristic of an authorized user will the activation circuit be completed and the device 100 enabled.

In some embodiments, the sensor 112 may be a fingerprint scanner. In other embodiments, the sensor 112 may be a retinal scanner. In still other embodiments, other biometric sensors may be used to record non-optical biometric characteristic of a prospective user. The sensor 112 could be, for example, a sound recording system usable to obtain vocal data, which can be used to identify a voice pattern.

In any of the above embodiments, the authorization control device 110 may comprise a cable intermediate the interface 114 and the scanner portion 112 to facilitate the scanning or sensing of the biometric characteristic. Depending on the embodiment, data obtained from the sensor 112 may be received and processed by the vaporizer control processor 190 or by the authorization device data processor 115.

In most cases, it will be desirable to require connection of the authorization control device 110 during scanning, authorization, and use of the vaporizer 100. In some embodiments, however, it may be desirable to allow for the authorization control device 110 to be separated from the vaporizer 100 for scanning or sensing the biometric characteristic, and then, within a short, predetermined time interval connection to the vaporizer 100 for activation thereof. In such cases, data obtained via the sensor 112 may be stored in the authorization control device storage medium 116 for access by either the vaporizer control processor 190 or by the authorization device data processor 115 upon connection of the authorization control device 110 to the activation circuit. In these and other embodiments, it may be desirable to allow separation of authorization control device 110 from the vaporizer 100 after authorization has been established. In such embodiments, the on-board control processor 190 may be configured to allow operation for a certain period of time before re-authorization is required. Alternatively, the control processor 190 could be configured to allow operation for as long as the device is in continuous use. In this context, “continuous use” would refer to continued periodic activation of the device with no more than a predetermined interval between activations.

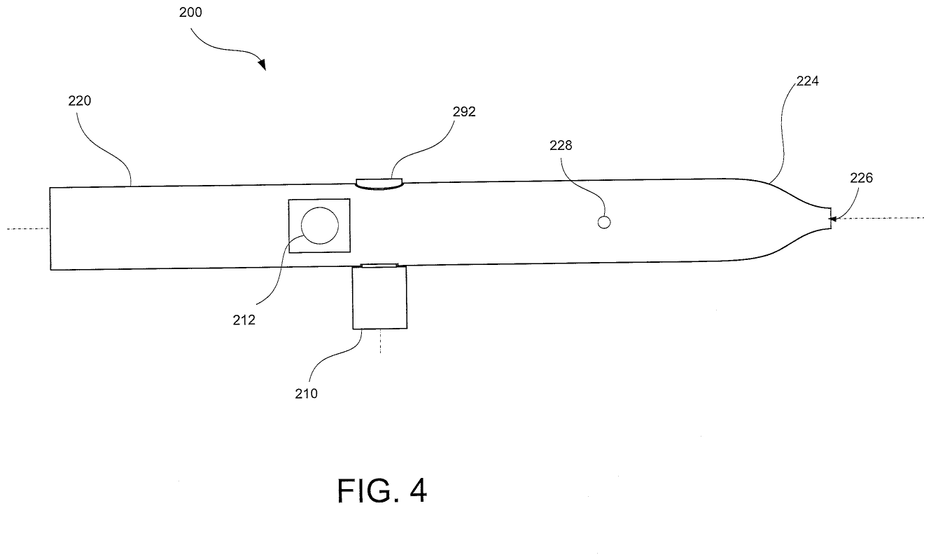

A significant advantage of the personal vaporizer 100 is that the biometric scanner or sensor is not part of the vaporizer 100 itself. Nevertheless, it is possible to have a configuration in which the biometric scanner is permanently mounted to the device, but that still requires the use of an authorization control device. Such an embodiment is illustrated in FIG. 4. In this embodiment, a personal vaporizer 200 has a cylindrical casing 220, air inlets 228, a mouthpiece 224 having an exit passage 226. The internal features of the vaporizer 200 are substantially similar to those of the vaporizer 100 of FIG. 1. The vaporizer 200 differs, however, in that the vaporizer 200 itself comprises a biometric scanner 212 mounted to the casing 220. The sensor 212 may be in data communication with an on-board vaporizer control processor (not shown) or an authorization control device data processor (not shown) either of which may be configured to receive and process data received from the sensor 212. The operation and requirements of the authorization control device 210 (shown in engagement with the communication port 294 of the vaporizer 200) are similar to those of the authorization control device 110, but without the scanning function.

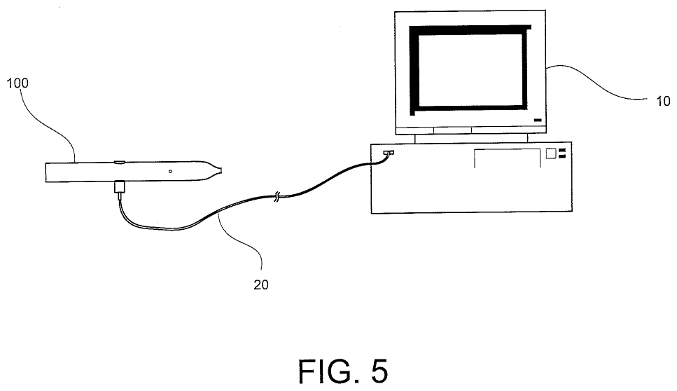

In both of the above embodiments, the communication port allows the connection of the on-board control processor to other external devices. As shown in FIG. 5, the control processor 190 of the personal vaporizer 100 can be connected to a desk top or other data processing system 10 using a standard USB cable. The control processor 190 and communication port 194 can be configured for connection to and communication with any processing device including smart phones, smart pads, transaction processing devices, or other telecommunication devices. In some embodiments, the personal vaporizer control processor 190 or authorization control device data processor 115 may be configured for wireless communication (e.g., Bluetooth or near field communication (NFC)) with external data processors 10. In particular embodiments, the control processor 190 may be configured to receive authorization information from a merchant processor 10 (e.g., at the time of purchase of the vaporizer 100). Such information may be stored by the control processor 190 in an on-board data storage medium for use in verifying subsequent use authorization. Authorization data may, alternatively or in addition, be stored in an authorization control device storage medium. In some cases, the external data processor 10 may store the authorization data directly into either or both the vaporizer storage medium and the authorization control device storage medium. In some cases, the authorization information may be stored in a manner that prevents it from being removed or changed.

The various embodiments of the invention can be used in conjunction with various authorization control methods structured to prevent unauthorized use of a personal vaporizer. In general, these methods involve the storage of a biometric characteristic of an authorized user (or users) in the authorization control device or the vaporizer's on-board control processor either by the authorized user himself or by a control authority. Once stored, the authorized user's characteristic can be compared to prospective users and activation of the vaporizer allowed only if the prospective user's characteristic matches the stored characteristic.

Variations of the basic authorization control approach can be used to assure that classes of users (e.g., under-age users) are prevented from using personal vaporizers according to the invention. One such method M100, illustrated in the block diagram of FIG. 5, provides for establishing an authorized user characteristic at the time of purchase of a personal vaporizer 100 according to the invention. The method M100 begins at S110. At S120, a vaporizer purchase transaction is initiated between a retailer and a buyer at a retail establishment. At S130, the retailer verifies the eligibility of the buyer to purchase the vaporizer 100 (e.g., by verifying age). At S140, the vaporizer 100 may be connected to a processing system 10 of the retailer via a USB cable 20 or via wireless communication. Communication between the control processor 190 of the vaporizer 100 and the retailer processing system allows the latter to record information in on-board storage for the vaporizer 100 (e.g., serial number) and associate it with the transaction. Optionally, other information may be obtained from the buyer and associated with the transaction and/or the vaporizer serial number. At S150, the buyer obtains an authorization control device 110 usable with the vaporizer 100. The authorization control device 110 may be obtained as part of the current purchase transaction or may have been previously obtained by the buyer. The authorization control device 110 may include a biometric characteristic sensor as previously described. At S160, user-specific information is obtained and permanently stored in a memory of the authorization control device 110 (or, in some embodiments, a memory of the on-board control processor 190). In some embodiments, the user-specific information may be a biometric characteristic, which may be obtained using the control device sensor. At S170, an identifier for the authorization control device 110 and/or the stored user information may optionally be associated with an identifier (e.g., serial number) of the vaporizer 100. In some embodiments, the biometric characteristic storage and association steps can only be conducted by the retailer or other control authority. The method ends at S190.

It will be understood that, in embodiments where the user-specific information (e.g., a biometric characteristic) is stored in the authorization control device 110, the storage action need only be done once. The authorization control device 110 can then be used for multiple vaporizers 100. Each time a vaporizer is purchased, the authorization control device (with the previously stored biometric characteristic) need only be associated with the newly purchased vaporizer at the time of purchase. Accordingly, the method could include, prior to S150, a query as to whether the buyer already has an authorization control device. If yes, a verification step could be added to assure the authorization control device carries the proper biometric characteristic. If it does, the method would skip to S170. If it does not, the method would proceed with S160.

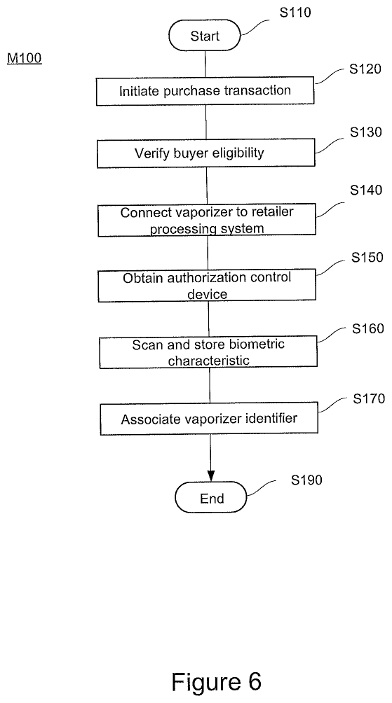

A different variation of the authorization control method is illustrated in FIG. 6. The method M200 begins at S210 and at S220, a buyer purchases a vaporizer according to the invention (e.g. vaporizer 100). No other registration or authorization actions are required at the time of purchase. Thus, the purchase could be made on line or at a brick and mortar retailer. At S230, the buyer logs onto a registration website, which may be administered, for example, by the vaporizer manufacturer or seller. At S240, a connection is established between the website administrator and the vaporizer. Typically, this will be accomplished in part, by the buyer connecting the vaporizer to a processing device being used to connect to the registration website. At S250, vaporizer identification information (e.g., a serial number) is transmitted to the website administrator. This may be accomplished by an application on the processing device which reads the information from the on-board control processor and transmits via the website. Alternatively, the vaporizer serial number could be transmitted by the control processor of the vaporizer or manually entered by the buyer. At S260, the buyer submits information sufficient to identify the buyer and/or verify the buyer's eligibility to activate and use the vaporizer. This could include, for example, providing driver's license or other identification information sufficient for use by a third party to verify the buyer's age. At S270, the buyer's eligibility to register, activate and use the device is verified. At S280, a registration payment may optionally be requested and received from the buyer. At S290, an authorization signal is sent to the vaporizer via the buyer's processor. Upon receipt of this signal, the buyer at S295 can connect an authorization control device to the vaporizer and associate the vaporizer with the authorization control device and/or a biometric characteristic stored therein. The biometric characteristic may be scanned and stored in the authorization control device at the time or it may have been previously stored in the device. The method ends at S290.

While the foregoing illustrates and describes exemplary embodiments of this invention, it is to be understood that the invention is not limited to the construction disclosed herein. The invention can be embodied in other specific forms without departing from the spirit or essential attributes.

1. A personal vaporizer comprising:
a vaporizer case defining a vaporizer interior;
a vaporization chamber within the vaporizer interior;
a fluid reservoir configured for retaining a vaporizable fluid;
a fluid transport structure configured for transporting vaporizable fluid from the fluid reservoir to the vaporization chamber;
a heating element disposed within the vaporization chamber;
an air flow passage from one or more air intake openings in the case wall to the vaporization chamber;
a vaporization mixture flow passage extending from the vaporization chamber to an exit port;
an activation circuit connected to the heating element and configured to activate the heating element if use authorization criteria are met, the circuit comprising
a power source,
a vaporizer control processor,
an authorization control device that is selectively connectable to and disconnectable from the activation circuit, and
an activation mechanism configured and positioned for manual operation by a user to selectively complete the activation circuit when the authorization control device is connected and the use authorization criteria are met.

2. A personal vaporizer according to claim 1, wherein the activation mechanism is a manual switch mounted to the vaporizer case.

3. A personal vaporizer according to claim 1 further comprising
a communication port in electrical communication with the activation circuit, the communication port being positioned within an opening in the vaporizer case,
wherein the authorization control device comprises a communication interface configured for reception into and electrical engagement with the communication port, and
wherein the authorization criteria include a requirement that the communication interface of the authorization control device be in electrical engagement with the communication port.

4. A personal vaporizer according to claim 3 wherein the communication port is a USB port.

5. A personal vaporizer according to claim 3 further comprising:
a vaporizer data storage medium having first authorization information stored therein,
wherein the authorization control device comprises an authorization device data storage medium having second authorization information stored therein,
wherein the vaporizer control processor is in data communication with the data storage medium when the authorization control device is in electrical engagement with the communication port, and
wherein the vaporizer control processor is configured to, in response to an attempt to activate the vaporizer using the activation mechanism,
verify electrical engagement between the authorization control device and the communication port,
retrieve the second authorization information from the authorization device data storage medium,
determine use authorization using the first and second authorization information and the authorization criteria, and
responsive to a positive use authorization determination, activate the vaporizer by allowing power to flow through the activation circuit to the heating element.

6. A personal vaporizer according to claim 3 further comprising:
a vaporizer data storage medium having first authorization information stored therein,
wherein the authorization control device comprises
an authorization device data storage medium having second authorization information stored therein, and
an authorization device data processor in data communication with the authorization device data storage medium and in data communication with the vaporizer data storage medium when the authorization control device is in electrical engagement with the communication port,
the authorization device data processor being configured to, in response to an attempt to activate the vaporizer using the activation mechanism,
verify electrical engagement between the authorization control device and the communication port,
retrieve the first authorization information from the vaporizer data storage medium,
retrieve the second authorization information from the authorization device data storage medium,
determine use authorization using the first and second authorization information and the authorization criteria, and
responsive to a positive use authorization determination, activate the vaporizer by allowing power to flow through the activation circuit to the heating element.

7. A personal vaporizer according to claim 3 further comprising:
a vaporizer data storage medium having first authorization information stored therein, the authorization information including at least one biometric characteristic for each of one or more authorized users of the device,
wherein the authorization control device comprises a biometric sensor configured for obtaining biometric data from a potential user of the personal vaporizer,
wherein the vaporizer control processor is in data communication with the biometric sensor when the authorization control device is in electrical engagement with the communication port, and
wherein the vaporizer control processor is configured to,
verify electrical engagement between the authorization control device and the communication port,
receive biometric data for the potential user from the biometric sensor,
determine use authorization for the potential user using the biometric data, the authorization information, and the authorization criteria, and
responsive to a positive use authorization determination, activate the vaporizer by allowing power to flow through the activation circuit to the heating element.

8. A personal vaporizer according to claim 7 wherein the biometric characteristic is a fingerprint and the biometric sensor is or includes a fingerprint scanner.

9. A personal vaporizer according to claim 7 wherein the biometric characteristic is a retina scan and the biometric sensor is or includes a retina scanner.

10. A personal vaporizer according to claim 7 wherein the biometric characteristics is a voice pattern, the biometric sensor is or includes a mechanism for receiving vocal data, and the vaporizer control processor is configured to process the vocal data using voice analysis and recognition methods.

11. A personal vaporizer according to claim 3 further comprising:
a vaporizer data storage medium having authorization information stored therein, the authorization information including at least one biometric characteristic for each of one or more authorized users of the device,
wherein the authorization control device comprises
a biometric sensor configured for obtaining biometric data from a potential user of the personal vaporizer, and
an authorization device data processor in data communication biometric sensor and, when the authorization control device is in electrical engagement with the communication port, with the vaporizer data storage medium, the authorization device data processor being configured to
receive biometric data for the potential user from the biometric sensor,
retrieve the authorization information from the vaporizer data storage medium,
determine use authorization for the potential user using the biometric data, the authorization information, and the authorization criteria, and
responsive to a positive use authorization determination, activate the vaporizer by allowing power to flow through the activation circuit to the heating element.

12. A personal vaporizer according to claim 11 wherein the biometric characteristic is a fingerprint and the biometric sensor is or includes a fingerprint scanner.

13. A personal vaporizer according to claim 11 wherein the biometric characteristic is a retina scan and the biometric sensor is or includes a retina scanner.

14. A personal vaporizer according to claim 11 wherein the biometric characteristics is a voice pattern, the biometric sensor is or includes a mechanism for receiving vocal data, and the vaporizer control processor is configured to process the vocal data using voice analysis and recognition methods.

15. A method of authorizing use of a personal vaporizer having a vaporizer control processor, a vaporizer data storage medium, a communication port and an activation circuit including a heating element, an activation switch, and a power supply, the activating circuit being in a normally open configuration, the method comprising:
establishing data communication between the vaporizer control processor and an authorizing processing system;
receiving, by the vaporizer control processor from the authorizing processing system, first authorization information;
storing the first authorization information in the vaporizer data storage medium;
connecting an authorization control device to the communication port of the vaporizer;
determining, by one of the set consisting of the vaporizer control processor and an authorization control data processor of the authorization control device, using the first authorization information whether predetermined authorization criteria are met;
responsive to closure of the activation switch by a prospective user and a determination that the predetermined authorization criteria have been met, activating the vaporizer by closing the activation circuit to allow current to flow from the power supply to the heating element; and
responsive to closure of the activation switch by the prospective user and a determination that the predetermined authorization criteria have not been met, maintaining the activation circuit in the open configuration.

16. A method according to claim 15 wherein the first authorization information includes a biometric characteristic of an authorized user and the method further comprises:
receiving, from a biometric sensor by said one of the set consisting of the vaporizer control processor and an authorization control data processor of the authorization control device, biometric data for the prospective user,
wherein the action of determining whether predetermined authorization criteria are met includes comparing the biometric data to the biometric characteristic.

17. A method according to claim 15 wherein the biometric data is one of the set consisting of a retina scan and a fingerprint scan.

18. A method of authorizing use of a personal vaporizer having a vaporizer control processor, a vaporizer data storage medium, a communication port and an activation circuit including a heating element, an activation switch, and a power supply, the activating circuit being in a normally open configuration, the method comprising:
providing an authorization control device having an authorization device data storage medium;
determining a biometric characteristic of an authorized user of the vaporizer;
permanently storing in the authorization device storage medium by an authorization processing system, the biometric characteristic;
connecting the authorization control device to the communication port of the vaporizer;
receiving, from a biometric sensor by one of the set consisting of the vaporizer control processor and an authorization control data processor of the authorization control device, biometric data for a prospective user of the vaporizer;
determining, by said one of the set consisting of the vaporizer control processor and an authorization control data processor of the authorization control device, whether the biometric data matches the biometric characteristic stored in the authorization device storage medium;
responsive to closure of the activation switch by the prospective user and a determination that the biometric data matches the stored biometric characteristic, activating the vaporizer by closing the activation circuit to allow current to flow from the power supply to the heating element; and
responsive to closure of the activation switch by the prospective user and a determination that the biometric data does not match the stored biometric characteristic, maintaining the activation circuit in the open configuration.

19. A method according to claim 18 wherein the biometric data is one of the set consisting of a retina scan and a fingerprint scan.
